(19) United States
(12) Patent Application Publication
(10) Pub. No.: US 2010/0152411 A1
(43) Pub. Date: Jun. 17, 2010

(54) POLY(TRIMETHYLENE TEREPHTHALATE) WITH REDUCED WHITENING

(75) Inventors: Brett Collin Dobrick, Wilmington, DE (US); Benjamin Weaver Messmore, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/639,278

(22) Filed: Dec. 16, 2009

Related U.S. Application Data
(60) Provisional application No. 61/138,299, filed on Dec. 17, 2008.

(51) Int. Cl. C08G 63/16; C08G 63/00; C08G 63/18

(52) U.S. Cl. 528/305; 528/308; 528/302; 528/308.8

(57) ABSTRACT

The present invention relates to a process for making a non-whitening poly(trimethylene terephthalate)-based polymer, wherein the polymer is melt polymerized 1,3-propanediol and a terephthalate component in the presence of a co-monomer, wherein the poly(trimethylene terephthalate)-based polymer comprises a PTT cyclic dimer level below 2 wt. %.

### FIELD OF THE INVENTION

The present invention relates to a process of producing poly(trimethylene terephthalate) (PTT) copolymers produced in a melt polymerization process with low equilibrium levels of cyclic oligomer.

### BACKGROUND

The phenomenon of “blooming” is a common problem for polymeric materials. Incompatible materials added to polymers can migrate to the surface of the part, causing a “bloom” or “haze.” These defects have a negative effect on the cosmetic appearance of the material and sometimes can impact performance of the material. In polyester technology, blooming is a well researched phenomenon in polyester films and fibers, namely polyethylene terephthalate (PET) and polytrimethylene terephthalate (PTT). In the case of these polyesters the bloom is not an additive, but thermodynamic by-products of step polymerizations: cyclic oligomers. Cyclic oligomers exist at equilibrium during the melt polymerization process of polyesters. During the polymerization process, hydroxyl end groups back-bite onto the main polymer chain to form cyclic species. The melt equilibrium of cyclic oligomers in PTT is higher than the melt equilibrium of cyclic oligomers in PET or PBT. The most abundant cyclic oligomer of PTT, PTT cyclic dimer, exists at an equilibrium concentration of 2.5 wt. %. During elevated temperature aging tests, cyclic oligomers of PTT are known to bloom to the surface of molded parts.

Therefore, there is a need for a process for producing non-whitening PTT based polymers. The present invention fulfills such a need.

### SUMMARY OF THE INVENTION

The invention is directed to a process for making a non-whitening poly(trimethylene terephthalate)-based polymer, comprising melt polymerizing 1,3-propanediol and a terephthalate component in the presence of a co-monomer, wherein the poly(trimethylene terephthalate)-based polymer comprises a PTT cyclic dimer level below 2 wt. %.

### BRIEF DESCRIPTION OF THE FIGURES/DRAWINGS

FIGS. 1A-E shows optical microscopy images of pressed films of copolymers exposed to the elevated temperature aging test.

### DETAILED DESCRIPTION

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless otherwise stated, all percentages, parts, ratios, etc., are by weight.

Poly(trimethylene terephthalate) Component

As indicated above, the polymer component comprises a predominant amount of a poly(trimethylene terephthalate).

Poly(trimethylene terephthalate) suitable for use in the invention are well known in the art, and conveniently prepared by polycondensation of 1,3-propane diol with terephthalic acid or terephthalic acid equivalent.

By “terephthalic acid equivalent” is meant compounds that perform substantially like terephthalic acids in reaction with polymeric glycols and diols, as would be generally recognized by a person of ordinary skill in the relevant art. Terephthalic acid equivalents for the purpose of the present invention include, for example, esters (such as dimethyl terephthalate), and ester-forming derivatives such as acid halides (e.g., acid chlorides) and anhydrides.

Preferred are terephthalic acid and terephthalic acid esters, more preferably the dimethyl ester. Methods for preparation of poly(trimethylene terephthalate) are discussed, for example in U.S. Pat. No. 6,277,947, U.S. Pat. No. 6,326,456, U.S. Pat. No. 6,657,044, U.S. Pat. No. 6,35,3062, U.S. Pat. No. 6,53,8076, US2003/0220465A1 and commonly owned U.S. patent application Ser. No. 11/638,919 (filed 14 Dec. 2006, entitled “Continuous Process for Producing Poly(trimethylene Terephthalate)”) which are all incorporated by reference.

The 1,3-propanediol for use in making the poly(trimethylene terephthalate) is preferably obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. No. 5,633,362, U.S. Pat. No. 5,686,276 and U.S. Pat. No. 5,821,092 which are incorporated by reference. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The polytrimethylene terephthalate based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and polytrimethylene terephthalate based thereon, may be distinguished from similar compounds produced from a petrochemical source or from fossil fuel carbon by dual carbon-isotopic finger printing. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 49900, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material) f_{M≈}1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated ‰, and are calculated as follows:

$${δ}^{13} C ≡ \frac{{(}^{13} C {/}^{12} C ) sample - {(}^{13} C {/}^{12} C ) standard}{{(}^{13} C {/}^{12} C ) standard} \times 1000 {\%}_{0}$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making poly(trimethylene terephthalate) will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1 which are all incorporated by reference.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

Poly(trimethylene terephthalate)s useful in this invention can be poly(trimethylene terephthalate) homopolymers (derived substantially from 1,3-propane diol and terephthalic acid and/or equivalent) and copolymers, by themselves or in blends. Poly(trimethylene terephthalate)s used in the invention preferably contain about 70 mole % or more of repeat units derived from 1,3-propane diol and terephthalic acid (and/or an equivalent thereof, such as dimethyl terephthalate).

The poly(trimethylene terephthalate) may contain up to 30 mole % of repeat units made from other diols or diacids. The other diacids include, for example, isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids. The other diols include ethylene glycol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol, and the longer chain diols and polyols made by the reaction product of diols or polyols with alkylene oxides.

More preferably, the poly(trimethylene terephthalate)s contain at least about 80 mole %, or at least about 90 mole %, or at least about 95 mole %, or at least about 99 mole %, of repeat units derived from 1,3-propane diol and terephthalic acid (or equivalent). The most preferred polymer is poly(trimethylene terephthalate) homopolymer (polymer of substantially only 1,3-propane diol and terephthalic acid or equivalent).

Generally, poly(trimethylene terephthalate) (PTT), is copolymerized with co-monomers, which have lower reactivity ratios relative to that of 1,3-propanediol. The co-monomers are selected from diols, polyols, carboxylic acids and ester derivatives thereof. More specifically, the carboxylic acids and ester derivatives include isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and 4,4′-sulfonyldibenzoic acid; and dimethyl, diethyl and dipropyl esters thereof. The diols and polyols include ethylene glycol, 1,4-butane diol, 1,2-propanediol, diethylene glycol, triethylene glycol, 1,3-butane diol, 1,5-pentane diol, 1,6-hexane diol, 1,2-cyclohexane dimethanol, 1,3-cyclohexane dimethanol, and 1,4-cyclohexane dimethanol, isosorbide, and diols and polyols comprising the reaction product of the diols or the polyols with alkylene oxides.

The terephthalate component for the polymers in the embodiments herein include terephthalic acid, dimethylterephthalate, and mixtures thereof. The co-monomers are added at levels between about 3 and 10 mole percent relative to the terephthalate component.

Shaped articles can be produced from the copolymers described in the embodiments herein. These articles can be molded parts for automotive end uses, as well as other articles contemplated by a user.

### Examples

In the examples, poly(trimethylene terephthalate) (PTT), which comprises a poly(trimethylene terephthalate) cyclic dimer level below about 2 weight percent, is copolymerized with other monomers, including cyclohexane dimethanol, 1,2 propane diol and sulfonyl dibenzoic acid. After melt polymerizing these polymers as described herein, the PTT copolymers are pressed into films and subjected to an elevated-temperature bloom test. The poly(trimethylene terephthalate) copolymers exhibit reduced cyclic oligomer blooming after these tests.

As used herein, 1,3-propanediol was obtained from DuPont/Tate & Lyle, Loudon, Tenn. All other chemicals and reagents were used as received from Sigma Aldrich, Milwaukee, Wis.

1,3 propane diol and terephthalic acid/dimethylterephthalate were co-polymerized with several different monomers. Films were then pressed of these copolymers and evaluated for blooming using an elevated-temperature blooming test. For this test, pressed films were wrapped in aluminum foil and placed in aluminum pans to provide uniform heating throughout the film. The wrapped films in aluminum pans were placed in a closed oven (no vacuum/purge) for various times at elevated temperatures. Oligomer blooming can be observed over a range of temperatures, but it was found 147° C. for 24 hours to be good conditions to observe the oligomer bloom as it was shown to be repeatable and reproducible and gave results relatively quickly. Oligomer blooming was evaluated by visual inspection for oligomer blooming.

### Procedure for Melt-Pressing Copolymer Films:

Copolymer films were melt-pressed using a Pasedena Press, taking the 2 grams of copolymer up to the melt at 260° C. for 3 minutes, maintaining contact between the plates and the polymer. After the polymer had melted, a film was pressed to 5,000 PHI. The film was then quenched to 0° C.

### Procedure for the Blooming Test:

Films were wrapped in aluminum foil and placed in aluminum pans and the pans placed in a closed oven in an air atmosphere with no purging for twenty four hours at 147° C. Films were evaluated using optical microscopy for blooming.

### Example 1. (Comparative)

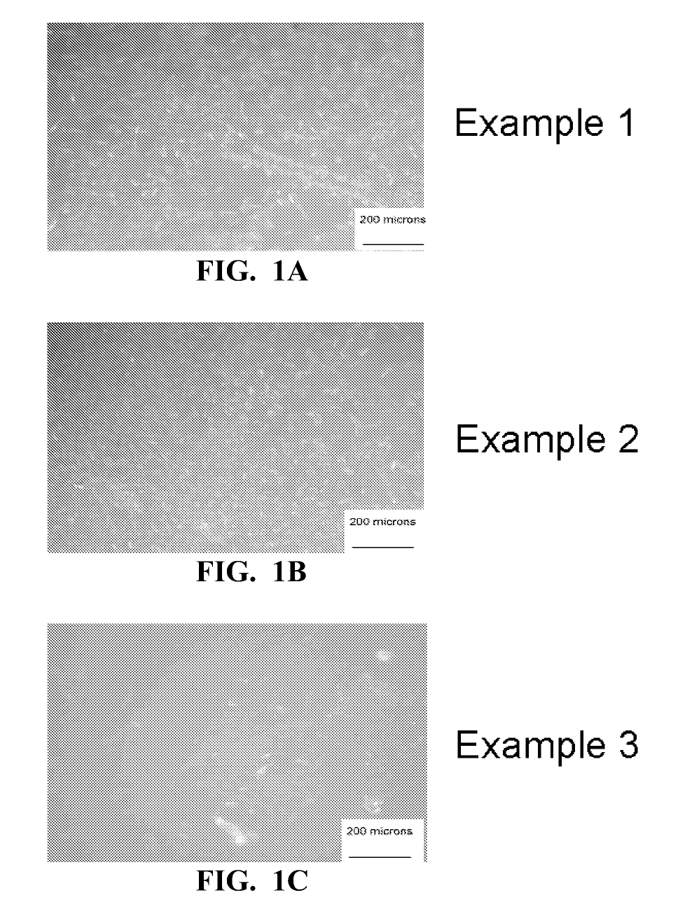

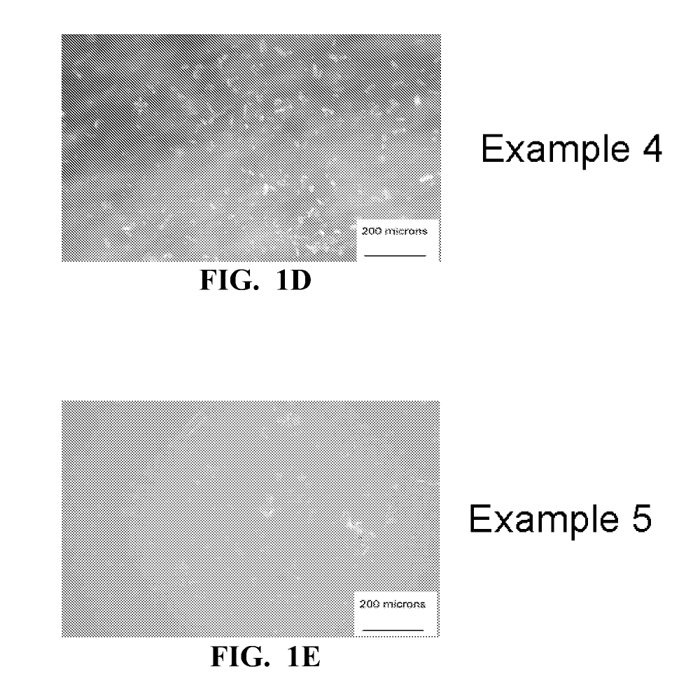

The polymerization of 1,3 propane diol and dimethyl terephthalate with results as shown in FIG. 1A.

Dimethylterephthalate (130.0 g, 0.67 mol), and 1,3-Propanediol (91.8 g, 1.21 mol) were charged to a 500 mL three necked round bottom flask. An overhead stirrer and a distillation condenser were attached. The reactants were stirred at a speed of 10 rpm. The reaction mass was kept under N₂ purge atmosphere. The contents were degassed two times by evacuating down to 500 mtorr and refilling back with N₂ gas. The flask was immersed in a preheated metal batch set at 160° C. The solids were allowed to completely melt at 160° C. and the stirrer speed was slowly increased to 180 rpm. 64 μl of catalyst Tyzor® TPT was added under a N₂ blanket. The temperature was increased to 210° C. The system was maintained at 210° C. for 20 minutes to distill off most of the methanol. The temperature was increased to 225° C. and further increased to 240° C. and held constant for 2 hrs. Finally the temperature was increased to 250° C. and was held constant for few minutes. The nitrogen flush was closed off and vacuum ramp was started. After 36 min, the vacuum reached a value of 44 mtorr. The reaction was maintained under vacuum for approximately 3 hr and 15 min.

### Example 2

The polymerization of 1,3 propane diol, 1,4-Cyclohexanediol (5.0 mol % with respect DMT) and dimethyl terephthalate with results as shown in FIG. 1B.

Dimethylterephthalate (122.4 g, 0.63 mol), 1,3-Propanediol (81.97 g, 1.08 mol) and 1,4-Cyclohexanediol (8.1 g, 0.056 mol) were charged to a 500 mL three necked round bottom flask. An overhead stirrer and a distillation condenser were attached. The reactants were stirred at a speed of 10 rpm. The reaction mass was kept under N₂ purge atmosphere. The contents were degassed three times by evacuating down to 500 mtorr and refilling back with N₂ gas. The flask was immersed in a preheated metal batch set at 160° C. and the stirrer speed was slowly increased to 180 rpm.

The solids were allowed to completely melt at 160° C. 71 μl of catalyst Tyzor® TPT was added under a N₂ blanket. The temperature was increased to 210° C. The system was maintained at 210° C. for 45 minutes to distill off most of the methanol. Finally, the temperature was increased to 250° C. and was held constant for 30 min. The nitrogen flush was closed off and vacuum ramp was started. After 52 min, the vacuum reached a value of 51 mtorr. The reaction was maintained under vacuum for approximately 3 hr.

### Example 3

The polymerization of 1,3 propane diol, 1,4-Cyclohexanediol (10.0 mol % with respect DMT) and dimethyl terephthalate with results as shown in FIG. 1C.

Dimethylterephthalate (122.4 g, 0.63 mol), 1,3-Propanediol (77.66 g, 1.02 mol) and 1,4-Cyclohexanediol (16.35 g, 0.11 mol) were charged to a 500 ml three necked round bottom flask. An overhead stirrer and a distillation condenser were attached. The reactants were stirred at a speed of 10 rpm. The reaction mass was kept under N2 purge atmosphere. The contents were degassed three times by evacuating down to 500 mtorr and refilling back with N2 gas. The flask was immersed in a preheated metal batch set at 170° C. and the stirrer speed was slowly increased to 180 rpm. The solids were allowed to completely melt at 170° C. 63 μl of catalyst Tyzor® TPT was added under a N2 blanket. The temperature was increased to 210° C. The system was maintained at 210° C. for 45 minutes to distill off most of the methanol. Finally the temperature was increased to 250° C. and was held constant for 30 min. The nitrogen flush was closed off and vacuum ramp was started. After 60 min, the vacuum reached a value of 54 mtorr. The reaction was maintained under vacuum for approximately 2 hr and 24 min.

### Example 4

### The polymerization of 1,3 propane diol, 1,2-Butanediol (5.0 mol % with respect DMT) and dimethyl terephthalate with results as shown in FIG. 1D.

Dimethylterephthalate (122.4 g, 0.63 mol), 1,3-Propanediol (81.97 g, 1.08 mol) and 1,2-Butanediol (5.11 g, 0.057 mol) were charged to a 500 mL three necked round bottom flask. An overhead stirrer and a distillation condenser were attached. The reactants were stirred at a speed of 10 rpm. The reaction mass was kept under N₂ purge atmosphere. The contents were degassed three times by evacuating down to 500 mtorr and refilling back with N₂ gas. The flask was immersed in a preheated metal batch set at 160° C. and the stirrer speed was slowly increased to 180 rpm. The solids were allowed to completely melt at 170° C. 71 μl of catalyst Tyzor® TPT was added under a N₂ blanket. The temperature was increased to 210° C. The system was maintained at 210° C. for 45 minutes to distill off most of the methanol. Finally the temperature was increased to 250° C. and was held constant for 30 minutes. The nitrogen flush was closed off and vacuum ramp was started. After 47 min, the vacuum reached a value of 50 mtorr. The reaction was maintained under vacuum for approximately 2 hr and 24 min.

### Example 5

The polymerization of 1,3 propane diol, terephthalic acid, and 4,4′-Sulfonyldibenzoic acid (replacing 5.0 mol % of TPA with SDBA) with results as shown in FIG. 1E.

The first day, terephthalic acid (78.91 g, 0.475 mol), 4,4′-Sulfonyldibenzoic acid (7.66 g, 0.025 mol) and 1,3-Propanediol (76.1 g, 1.0 mol) were charged to a 500 mL three necked round bottom flask. An overhead stirrer and a distillation condenser were attached. The reactants were stirred at a speed of 180 rpm. The reaction mass was purged with N₂ and kept under N₂ atmosphere. The flask was immersed in a preheated metal batch set at 160° C. 34 μl of catalyst Tyzor® TPT was added under a N₂ blanket. The temperature was increased to 200° C. The temperature was further increased to 240° C. over a period of 2 hrs and 40 min. The system was maintained at 240° C. for 2 hrs and 20 min.

Stirring was stopped and the metal bath was lowered down. The contents of the flask were allowed to stand under N₂ atmosphere. After a period of 4 days the flask was re-immersed in a preheated metal bath set at 150° C. The bath temperature was further increased to 200° C. The stirring was started after some melting of the solids was observed and it was gradually increased to 180 rpm. Additional 34 μl of catalyst Tyzor® TPT was added under a N₂ blanket. The temperature was increased to 225° C. and finally to 250° C. and was held constant for 90 minutes. The nitrogen flush was closed off and vacuum ramp was started. After 22 min, the vacuum reached a value of 55 mtorr. The reaction was maintained under vacuum for approximately 3 hr.

What is claimed is:

1. A process for making a non-whitening poly(trimethylene terephthalate)-based polymer, comprising melt polymerizing 1,3-propanediol and a terephthalate component in the presence of a co-monomer, wherein the poly(trimethylene terephthalate)-based polymer comprises a PTT cyclic dimer level below 2 wt. %.

2. The process of claim 1, further comprises forming the non-whitening poly(trimethylene terephthalate)-based polymer into a film wherein the film exhibits reduced cyclic oligomer blooming after elevated temperature aging tests.

3. The process of claim 1, wherein the co-monomers have lower reactivity ratios relative to that of 1,3-propane diol.

4. The process of claim 3, wherein the co-monomers are selected from the group consisting of diols, polyols and carboxylic acids and ester derivatives thereof.

5. The process of claim 4, wherein the carboxylic acids and ester derivatives thereof are selected from the group consisting of isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and 4,4′-sulfonyldibenzoic acid; and dimethyl, diethyl and dipropyl esters thereof.

6. The process of claim 4, wherein the diols and polyols are selected from the group consisting of ethylene glycol, 1,4-butane diol, 1,2-propanediol, diethylene glycol, triethylene glycol, 1,3-butane diol, 1,5-pentane diol, 1,6-hexane diol, 1,2-cyclohexane dimethanol, 1,3-cyclohexane dimethanol, and 1,4-cyclohexane dimethanol, isosorbide, and diols and polyols comprising a reaction product of the diols or the polyols with alkylene oxides.

7. The process of claim 1, wherein the terephthalate component is selected from the group consisting of terephthalic acid, dimethylterephthalate and mixtures thereof.

8. The process of claim 1, wherein the co-monomer is added at levels of between about 3 and 10 mole percent relative to the terephthalate component.

9. A shaped article having surfaces, the article comprising a product of the process of claim 1.

10. The shaped article of claim 9, having fewer oligomeric deposits on the surfaces after exposing the article to elevated temperatures.
